(19) United States
(12) Patent Application Publication
(10) Pub. No.: US 2024/0018293 A1
(43) Pub. Date: Jan. 18, 2024

(54) Use of Raw Gel in Formulations on the Basis of Polyurethane Dispersions

(71) Applicant: COVESTRO DEUTSCHLAND AG, Leverkusen (DE)

(72) Inventors: Peter Kueker, Leverkusen (DE); Christoph Thiebes, Köln (DE); Udo Wipperfuerth, Köln (DE); Juergen Kempkes, Köln (DE); Dirk Dijkstra, Köln (DE); Ruediger Musch, Bergisch Gladbach (DE)

(21) Appl. No.: 18/250,388

(22) PCT Filed: Oct. 22, 2021
(86) PCT No.: PCT/EP2021/079304

§ 371 Date: Apr. 25, 2023

(30) Foreign Application Priority Data
Oct. 26, 2020 (EP) 20203814.7

(51) Int. Cl. C08G 18/42; C08G 18/72; C08G 18/32; C08G 18/08

(52) U.S. Cl. CPC C08G 18/4238; C08G 18/72; C08G 18/32; C08G 18/0819; C08G 2170/80; C08G 2130/00; C08G 2250/00

(57) ABSTRACT

The present invention relates to an aqueous dispersion at least containing (A) at least one polyurethane, (B) at least one fresh sol and (C) optionally further additives, wherein the at least one polyurethane is anionically hydrophilized, to a process for producing the dispersion, to the use of the dispersion for producing an adhesive composition, to a corresponding adhesive composition, to an adhesive laminate containing at least one substrate bonded with this adhesive composition, to a process for producing an adhesive laminate and to the use of a fresh sol for achieving a thickening effect in an aqueous polyurethane dispersion.

### CROSS-REFERENCE TO RELATED APPLICATIONS

This application is the United States national phase of International Application No. PCT/EP2021/079304 filed Oct. 22, 2021, and claims priority to European Patent Application No. 20203814.7 filed Oct. 26, 2020, the disclosures of which are hereby incorporated by reference in their entireties.

### BACKGROUND OF THE INVENTION

### Field of the Invention

The present invention relates to an aqueous dispersion at least containing (A) at least one polyurethane, (B) at least one fresh sol and (C) optionally further additives, wherein the at least one polyurethane is anionically hydrophilized, to a process for producing the dispersion, to the use of the dispersion for producing an adhesive composition, to a corresponding adhesive composition, to an adhesive laminate containing at least one substrate bonded with this adhesive composition, to a process for producing an adhesive laminate and to the use of a fresh sol for achieving a thickening effect in an aqueous polyurethane dispersion.

### Description of Related Art

Aqueous, sprayable contact adhesives for achieving wet bonding are produced predominantly on the basis of polychloroprene dispersions. They are employed in various sectors, in particular for foam bonding in mattresses and furniture. Two processes are typically employed. In the 2-component process (2K process) adhesive formulation and aqueous coagulant are simultaneously mixed by atomization in a spray gun having two nozzles, see DE 10 2006 045384 A1 for example. In the 1-component process (1K process) an adhesive formulation is sprayed using a spray gun having one nozzle, see for example EP 0 624 634 A1 or EP 0 470 928 A1.

Adhesive formulations based on aqueous polyurethane dispersions have become established in demanding industrial uses, for example in shoe manufacture, in the bonding of parts for motor vehicle interiors, in sheet lamination or in the bonding of textile substrates.

When using such dispersions for bonding substrates it is customary to employ thermal activation. Here, the dispersion is applied to the substrate and after complete evaporation of the water the adhesive layer is activated and converted into an adherable state by heating, for example with an infrared radiator. Dispersions that are suitable for use of thermal activation are described for example in U.S. Pat. No. 4,870,129. The use of specific mixtures of diisocyanates according to the acetone process then makes it possible to obtain suitable, aqueous polyurethane or polyurethane-polyurea dispersions. The films obtainable therefrom exhibit good thermal activatability.

Mixtures of special polyester-based polyurethane dispersions with sulfonate groups and aqueous aliphatic polyurethane dispersions are described in U.S. Pat. No. 6,797,764. These exhibit good adhesion to a multiplicity of metal and plastic substrates after thermal activation.

The use of polyurethane or polyurethane-polyurea dispersions may also employ the process of wet bonding. Here, bonding occurs immediately after adhesive application. However, mechanical securing of the parts to be joined is necessary until the adhesive has set. This method is often used for the bonding of wood or textile substrates.

EP 1 664 227 B1 describes adhesives based on polyurethane dispersions. Due to the addition of silica sols having a particle diameter of at least 50 nm these dispersions show a higher initial heat resistance during bonding, wherein silica sols of smaller particle size do not show this effect. The formulations disclosed are low-viscosity formulations.

The disadvantage of the recited prior art processes is the low viscosity of the employed mixtures. In addition, a not inconsiderable portion of the adhesive may no longer be available for bonding due to settling, sinking and penetration into the pores of the foam substrates, so-called “sagging”.

In order to prevent “sagging” or in the case of spray application “overspray” the viscosity of the formulations is generally increased to a range of about 2000 to 4000 mPa·s. This is typically effected using organic thickeners which are toxicologically concerning and disadvantageously elevate the content of volatile organic compounds (VOC or VVOC).

WO 2003/016370 A1 describes a process for producing silica-polyurethane nanocomposites. In the first step a silica sol is produced from the silica solution and admixed with polyols. The water is removed and the polyol-silica colloid is reacted with diisocyanate and other substances to afford a silica-polyurethane. The objective is to improve the fire safety of polyurethane through incorporation of silica sol thereinto.

WO 2001/090271 A1 describes a sprayable 1-component polyurethane adhesive formulation with addition of pyrogenic silica. The objective is to increase the rigidity of the adhesive through the addition of the pyrogenic silica while maintaining good spraying characteristics. This is achieved by modifying the prepolymers and functionality of the polyisocyanates during production of the polyurethane dispersion.

EP 2 486 072 B1 discloses a sprayable polyurethane adhesive formulation having good rigidity and good spray gun sprayability with addition of thixotropic thickeners, phthalates and pyrogenic silica.

A stabilization of fresh sol by polyurethane dispersions and the resulting increased viscosity and extended storage stability of the formulations as well as an increased heat resistance of the bonds is described in the prior art.

### SUMMARY OF THE INVENTION

It is accordingly an object of the present invention to provide aqueous dispersions based on polyurethane which may be used as adhesives, in particular in thermal activation and in wet bonding, and which exhibit exceptional adhesive properties. These dispersions moreover shall not exhibit the disadvantages described in the prior art—the adhesive formulations shall especially exhibit a viscosity suitable for the application, shall exhibit long-term storage stability without coagulation, shall have a stable viscosity and shall contain thickeners that are toxicologically unconcerning and do not increase the proportion of volatile organic compounds (VOC). The aqueous dispersions according to the invention shall exhibit increased heat resistance relative to the prior art.

These objects are achieved by the aqueous dispersion according to the invention at least containing
(A) at least one polyurethane,
(B) at least one fresh sol and
(C) optionally further additives,
wherein the at least one polyurethane is anionically hydrophilized.

### BRIEF DESCRIPTION OF THE DRAWING

FIG. 1 shows a device for determining initial strength.

### DETAILED DESCRIPTION

The dispersion according to the invention, in particular the components (A), (B) and (C), are described in detail below.

Component (A)

The aqueous dispersion according to the invention contains at least one polyurethane, wherein said polyurethane is anionically hydrophilized.

The present invention preferably relates to the dispersion according to the invention, wherein the at least one polyurethane is formed from
(a) at least one difunctional polyester polyol preferably having a molecular weight of 400 to 5000 g/mol,
b) at least one polyisocyanate and
c) at least one chain extender,
d) optionally further units distinct from a), b) and c),
wherein at least one of the components a), b), c) and d) bears at least one anionically hydrophilizing group.

It is preferable according to the invention when component c) bears at least one anionically hydrophilizing group. It is more preferable according to the invention when components a), b) and d) do not bear any anionically hydrophilizing groups.

Anionically hydrophilizing groups in the context of the present invention include for example one or more sulfonate groups, one or more carboxylate groups and/or one or more phosphate groups. According to the invention the term anionic groups also comprises groups that may be converted into anionic groups. Accordingly, carboxylic acid, sulfonic acid or phosphoric acid groups are also regarded as anionically hydrophilizing groups.

Component (a):

The polyurethane present according to the invention is preferably formed from at least one difunctional polyester polyol preferably having a molecular weight of 400 to 5000 g/mol as component a).

It is preferable according to the invention when the polyester polyols employed as component a) are crystalline or semicrystalline difunctional polyester polyols. Methods for determining the presence or the absence of crystallinity are known to those skilled in the art, for example Differential Scanning calorimetry (DSC) according to DIN 65467: 1999-03.

It is further preferable when the polyester polyols employed are linear or else slightly branched polyester polyols which are further preferably based on dicarboxylic acids and/or derivatives thereof, such as anhydrides, esters or acid chlorides and, preferably aliphatic, linear polyols. Mixtures of dicarboxylic acids and/or derivatives thereof are also suitable.

Suitable dicarboxylic acids are for example selected from the group consisting of adipic acid, succinic acid, sebacic acid, dodecanedioic acid and mixtures thereof. Preference is given to succinic acid, adipic acid and sebacic acid and mixtures thereof, particular preference to succinic acid and adipic acid and mixtures thereof, and very particular preference to adipic acid. The recited dicarboxylic acids are employed in an amount of at least 90 mol %, preferably 95 to 100 mol %, in each case based on the total amount of all carboxylic acids.

The preferably difunctional polyester polyols employed as component (a) may be produced for example by polycondensation of dicarboxylic acids with polyols. The polyols employed therefor preferably have a molecular weight of 62 to 399 g/mol, consist of 2 to 12 carbon atoms, are preferably unbranched, difunctional and/or preferably have primary OH groups.

Examples of polyols that may be used for producing the polyester polyols employed as component a) include polyhydric alcohols, for example ethanediol, di-, tri-, or tetraethylene glycol, propane-1,2-diol, di-, tri-, or tetrapropylene glycol, propane-1,3-diol, butane-1,4-diol, butane-1,3-diol, butane-2,3-diol, pentane-1,5-diol, hexane-1,6-diol, 2,2-dimethylpropane-1,3-diol, 1,4-dihydroxycyclohexane, 1,4-dimethylolcyclohexane, octane-1,8-diol, decane-1,10-diol, dodecane-1,12-diol or mixtures thereof.

Preferred polyol components for the polyester polyols a) are ethane-1,2-diol, butane-1,4-diol and hexane-1,6-diol, particular preference being given to butane-1,4-diol and hexane-1,6-diol, very particular preference to butane-1,4-diol.

The polyester polyols a) may be formed from one or more polyols. In a preferred embodiment of the present invention they are formed from just one polyol.

If the crystalline or semicrystalline difunctional polyester polyols having a number-average molecular weight of at least 400 g/mol and/or a melting temperature of at least 35° C. have a heat of fusion of at least 50 J/g, the polymer produced using these will regularly have a heat of fusion of at least 35 J/g. If desired, adjustment of the heat of fusion of the polymer can be achieved by a slight modification of the content of polyester polyol a) in the composition or by a small variation of the heat of fusion of the polyester polyol. These measures require only exploratory experiments and are completely within the practical experience of a person of average skill in the art in this field.

The production of polyester polyols a) is known from the prior art.

The number-average molecular weight of the polyester polyols a) is 400 to 5000 g/mol, preferably 1000 to 3000 g/mol, particularly preferably 1500 to 2500 g/mol, very particularly preferably 1800 to 2400 g/mol.

The melting temperature of the crystalline or semicrystalline polyester polyols is preferably at least 35° C., preferably 40° C. to 80° C., particularly preferably 42° C. to 60° C. and very particularly preferably 45° C. to 52° C. The heat of fusion is at least 20 J/g, preferably at least 30 J/g and particularly preferably at least 40 J/g.

Component a′):

In addition to the above-described polyester polyols (component a)) difunctional polyol components having a molecular weight of 62 to 399 g/mol may optionally also be present as component a′) according to the invention.

Such difunctional polyol components having a molecular weight of 62 to 399 g/mol (component a′)) include for example the polyols recited for production of the polyester polyols a). Low molecular weight polyester diols, polyether diols, polycarbonate diols or other polymer diols are in principle also suitable, provided they have a molecular weight of 62 to 399 g/mol.

Component (b):

Suitable components b) include any desired organic compounds having at least two free isocyanate groups per molecule. It is preferable to employ diisocyanates of formula Y(NCO)₂, wherein Y is a divalent aliphatic hydrocarbon radical having 4 to 12 carbon atoms, a divalent cycloaliphatic hydrocarbon radical having 6 to 15 carbon atoms, a divalent aromatic hydrocarbon radical having 6 to 15 carbon atoms or a divalent araliphatic hydrocarbon radical having 7 to 15 carbon atoms. Examples of such diisocyanates preferred for use include tetramethylene diisocyanate, methylpentamethylene diisocyanate, hexamethylene diisocyanate, dodecamethylene diisocyanate, 1,4-diisocyanatocyclohexane, 1-isocyanato-3,3,5-trimethyl-5-isocyanatomethylcyclohexane, 4,4′-diisocyanatodicyclohexylmethane, 4,4′-diisocyanato-2,2-dicyclohexylpropane, 1,4-diisocyanatobenzene, 2,4-diisocyanatotoluene, 2,6-diisocyanatotoluene, 4,4′-diisocyanatodiphenylmethane, 2,2′- and 2,4′-diisocyanatodiphenylmethane, tetramethylxylylene diisocyanate, p-xylylene diisocyanate, p-isopropylidene diisocyanate, and mixtures composed of these compounds.

It will be appreciated that it is also possible to additionally use proportions of higher-functionality polyisocyanates known per se in polyurethane chemistry, or else modified polyisocyanates known per se and for example comprising carbodiimide groups, allophanate groups, isocyanurate groups, urethane groups and/or biuret groups.

In addition to these simple diisocyanates, polyisocyanates containing heteroatoms in the radical linking the isocyanate groups and/or having a functionality of more than 2 isocyanate groups per molecule are also suitable. The former are, for example, polyisocyanates which have been produced by modification of simple aliphatic, cycloaliphatic, araliphatic and/or aromatic diisocyanates, are formed from at least two diisocyanates, and have a uretdione, isocyanurate, urethane, allophanate, biuret, carbodiimide, iminooxadiazinedione and/or oxadiazinetrione structure. An example of an unmodified polyisocyanate having more than 2 isocyanate groups per molecule is 4-isocyanatomethyloctane 1,8-diisocyanate (nonane triisocyanate) for example.

Components b) which are particularly preferred according to the invention are hexamethylene diisocyanate (HDI) and 1-isocyanato-3,3,5-trimethyl-5-isocyanatomethylcyclohexane (IPDI) and mixtures thereof.

Component c):

The component c) employed according to the invention is at least one chain extender. It is preferable according to the invention when component c) bears at least one anionically hydrophilizing group.

Preferred compounds bearing at least one anionically hydrophilizing group employed as component c) are selected from the group consisting of mono- and dihydroxycarboxylic acids, mono- and diaminocarboxylic acids, mono- and dihydroxysulfonic acids, mono- and diaminosulfonic acids and also mono- and dihydroxyphosphonic acids or mono- and diaminophosphonic acids, their alkali metal and ammonium salts and mixtures thereof.

The present invention therefore preferably relates to the aqueous dispersion according to the invention, wherein in the at least one polyurethane the compound employed as component c) bears the at least one anionically hydrophilizing group and is preferably selected from the group consisting of mono- and dihydroxycarboxylic acids, mono- and diaminocarboxylic acids, mono- and dihydroxysulfonic acids, mono- and diaminosulfonic acids and also mono- and dihydroxyphosphonic acids or mono- and diaminophosphonic acids, their alkali metal and ammonium salts and mixtures thereof.

Examples include dimethylolpropionic acid, dimethylolbutyric acid, hydroxypivalic acid, N-(2-aminoethyl)-β-alanine, N-(2-aminoethyl)-2-aminoethanesulfonic acid, N-(2-aminoethyl)-2-aminoethanecarboxylic acid, ethylenediaminepropyl- or -butylsulfonic acid, propylene-1,2- or -1,3-diamine-β-ethylsulfonic acid, malic acid, citric acid, glycolic acid, lactic acid, glycine, alanine, taurine, lysine, 3,5-diaminobenzoic acid, an addition product of IPDI and acrylic acid, see EP-A 0 916 647, example 1, and the alkali metal and/or ammonium salts thereof; the adduct of sodium bisulfite onto but-2-ene-1,4-diol, polyethersulfonate, the propoxylated adduct of 2-butenediol and NaHSO3, see DE-A 2 446 440, formulae I to III. Well-suited for salt formation are hydroxides of sodium, potassium, lithium and calcium hydroxide and tertiary amines such as triethylamine, dimethylcyclohexylamine and ethyldiisopropylamine.

Other amines may also be used for salt formation, for example ammonia, diethanolamine, triethanolamine, dimethylethanolamine, methyldiethanolamine, aminomethylpropanol and also mixtures of the recited amines and also other amines. These amines are advantageously added only only after the isocyanate groups have been largely converted.

Particularly preferred components c) are those having carboxyl and/or carboxylate and/or sulfonate groups.

Very particularly preferred components c) include N-(2-aminoethyl)-2-aminoethanesulfonic acid and N-(2-aminoethyl)-2-aminoethanecarboxylic acid, in particular N-(2-aminoethyl)-2-aminoethanesulfonic acid. Also very particularly preferred are salts of dimethylolpropionic acid.

Component (d):

Optional further units distinct from a), b) and c) that may be employed include for example polyoxyalkylene ethers containing at least one hydroxyl or amino group. The frequently used polyalkylene oxide polyether alcohols are obtainable in a manner known per se by alkoxylation of suitable starter molecules. Alkylene oxides suitable for the alkoxylation reaction are especially ethylene oxide and propylene oxide, which may be used in the alkoxylation reaction individually or else together.

Further compounds suitable as component d) include for example monoamines, diamines and/or polyamines and mixtures thereof.

Examples of monoamines are aliphatic and/or alicyclic primary and/or secondary monoamines such as ethylamine, diethylamine, the isomeric propyl- and butylamines, higher linear aliphatic monoamines and cycloaliphatic monoamines such as cyclohexylamine. Further examples are amino alcohols, i.e. compounds containing amino and hydroxyl groups in one molecule, for example ethanolamine, N-methylethanolamine, diethanolamine or 2-propanolamine. Examples of diamines are ethane-1,2-diamine, hexamethylene-1,6-diamine, 1-amino-3,3,5-trimethyl-5-aminomethylcyclohexane (isophoronediamine), piperazine, 1,4-diaminocyclohexane and bis(4-aminocyclohexyl)methane. Adipic dihydrazide, hydrazine and hydrazine hydrate are also suitable. Further examples are aminoalcohols, i.e. compounds containing amino and hydroxyl groups in one molecule, such as for example 1,3-diamino-2-propanol, N-(2-hydroxyethyl)ethylenediamine or N,N-bis(2-hydroxyethyl)ethylenediamine. Examples of polyamines are diethylenetriamine and triethylenetetramine.

It is preferable according to the invention when the polyurethane according to the invention contains at least one monoamine and/or at least one diamine as component d) in particular for adjusting the molar mass.

In a particular embodiment of the present invention the polyurethane employed according to the invention contains at the ends and/or along the polymer main chain at least one OH group which is further preferably attached via an aliphatic group selected from methylene, ethylene, propylene and/or butylene groups. It is further preferable when this at least one OH group is incorporated into the polyurethane according to the invention through the use of amino alcohols, i.e. compounds containing amino groups and hydroxyl groups in one molecule, as chain terminators in the polyurethane synthesis. Particular preference is given to the use of ethanolamine, N-methylethanolamine, diethanolamine or mixtures thereof.

It is preferable when the aqueous polyurethane dispersions according to the invention contain no external emulsifiers.

In a specific embodiment of the invention the at least one polyurethane contains a polyester of adipic acid and butane-1,4-diol as component a), butane-1,4-diol as component a′), 1-isocyanato-3,3,5-trimethyl-5-isocyanatomethylcyclohexane (IPDI) as component b), the sodium salt of N-(2-aminoethyl)-2-aminoethanesulfonic acid as component c) and diethanolamine as component d). It is further preferable when the polyurethane employed according to the invention is formed from these components, i.e. consists thereof.

The polyurethane preferably contains 50% to 95% by weight of component a), 0% to 10% by weight of component a′), 4% to 25% by weight of component b), 0.5% to 10% by weight of component c) and 0% to 30% by weight of component d), wherein the components present sum to 100% by weight.

In a particularly preferred form of the invention the polyurethane contains 65% to 92% by weight of component a), 0% to 5% by weight of component a′), 6% to 15% by weight of component b), 0.5% to 5% by weight of component c) and 0% to 25% by weight of component d), wherein the components present sum to 100% by weight.

In a very particularly preferred form of the invention the polymer contains 75% to 92% by weight of component a), 0% to 5% by weight of component a′), 8% to 15% by weight of component b), 0.5% to 4% by weight of component c) and 0% to 15% by weight of component d), wherein the components present sum to 100% by weight.

In an especially preferred form of the invention the polyurethane contains 80% to 90% by weight of component a), 0% to 3% by weight of component a′), 8% to 14% by weight of component b), 0.5% to 3% by weight of component c) and 0% to 10% by weight of component d), wherein the components present sum to 100% by weight.

When components a′) and/or d) are present they are generally present in an amount of at least 0.1% by weight.

In a preferred embodiment the at least one polyurethane according to the invention is semicrystalline or amorphous, preferably with a glass transition temperature Tg of −65° C. to 10° C.

The present invention therefore preferably relates to the dispersion according to the invention, wherein the at least one polyurethane is semicrystalline or amorphous, preferably with a glass transition temperature Tg of −65° C. to 10° C., determined by DSC measurement according to DIN 65467:1999-03.

The polyurethane according to the invention is referred to as semicrystalline or crystalline if in DSC measurement according to DIN 65467:1999-03 at a heating rate of 20 K/min it has a melting peak corresponding to an enthalpy of fusion >5 J/g, preferably >10 J/g, particularly preferably >20 J/g and very particularly preferably >40 J/g. The melting peak is caused by the melting of regular substructures in the polymer. The melting temperature is preferably in a range from 30° C. to 80° C., particularly preferably 40° C. to 70° C., very particularly preferably 42° C. to 55° C. The first heating is evaluated in order also to detect slow-crystallizing polymers. The polyurethane according to the invention is referred to as amorphous if it has no melting peak or a melting peak corresponding to an enthalpy of fusion of not more than 5 J/g.

Component A is generally present in the dispersion according to the invention in an amount of 60% to 99.9% by weight, preferably 85 to 99.6% by weight, in each case based on the total dispersion.

Component (B)

As component B) the aqueous dispersion according to the invention preferably employs at least one fresh sol.

In the context of the present invention “fresh sol” is to be understood as meaning an aqueous solution of silica.

Silica is unstable in its free state and is therefore produced in situ from various precursors to obtain a diluted solution of silica Si(OH)₄, so-called fresh sol, see for example U.S. Pat. Nos. 2,244,325 and 3,468,813.

On an industrial scale the production of fresh sol as the starting material may generally employ industrial waterglasses, for example sodium waterglasses having the composition Na₂O×3.34 SiO₂. Strongly alkaline sodium silicate solutions are produced therefrom. Potassium waterglasses may also be employed.

To produce the employed fresh sols it is preferable to use an alkali metal-free SiO₂ solution producible by removing the alkali metal cations from the waterglass. One possible method of dealkalization is the treatment of the diluted waterglass solutions with cation-exchange resins in the H⁺ form. Suitable ion-exchange resins are the Lewatit® types from Lanxess AG for example.

To this end it is preferable to pass waterglass solutions having a SiO₂ content below 10% by weight over exchange columns with acidic ion exchangers. Short residence times in the exchange zone, in which the pH of the solutions is 5 to 7, are important to avoid gelation of the solutions and silication of the exchange resin.

The resulting silica solution, i.e. the fresh sol desired according to the invention, is preferably storage stable at low pH and in heavily diluted solution.

The present invention therefore preferably relates to the dispersion according to the invention, wherein the at least one fresh sol has a pH of 1.0 to 3.5, preferably 1.5 to 3.0, particularly preferably 1.7 to 2.9.

The fresh sol according to the invention has a solids concentration of preferably 4% to 8% by weight, particularly preferably 5% to 6% by weight. The silica Si(OH)₄ is generally in equilibrium with other water-soluble oligosilicate molecules, see for example Cengiz Özmentin, Jan Schlomach, Matthias Kind, Polymerisationskinetik von Kieselsäure, Chemie Ingenieur Technik 2004, no. 12, page 76.

It is not preferable according to the invention to employ SiO₂ dispersions based on silica sol, silica gel, pyrogenic silica or precipitated silica as component B).

In contrast to the fresh sol employed according to the invention, silica sols are colloidal solutions of amorphous silicon dioxide in water, which are also referred to as silicon dioxide sols or silicic acid sols. They are formed by realkalization and by growth on existing silica sol particles, see for example DE 4033875 C2 and EP 0 572 888 A1. They are stabilized and concentrated by thermal treatment, see for example EP 0 569 813 B1, EP 1 905 741 or WO 2004/007367 A1.

Silica gels are understood by those skilled in the art to mean colloidally formed or unformed silica of elastic to solid consistency with loose to dense pore structure. The silica is in the form of highly condensed polysilicic acid. Siloxane and/or silanol groups are disposed on the surface. Production of silica gels is effected from waterglass by reaction with mineral acids.

In the case of precipitated silica waterglass is treated with acid and water. This forms colloidal primary particles that coalesce to form agglomerates. The specific surface is 30 to 800 m²/g according to DIN 66131 and the primary particle size is 5 to 100 nm. The primary particles of these silicas in solid form are firmly crosslinked to form secondary agglomerates.

Pyrogenic silica is producible from tetrachlorosilane by flame hydrolysis. It has a virtually pore-free surface and has a specific surface area of 50 to 600 m²/g according to DIN 66131 and a primary particle size of 5 to 50 nm. The pyrogenic silica produced by arc methods has a specific surface area of 25 to 300 m²/g according to DIN 66131 and a primary particle size of 5 to 500 nm.

Component (B) is generally present in the dispersion according to the invention in an amount of 0.1% to 40% by weight, preferably 0.4% to 15% by weight, in each case based on the total dispersion.

Component (C)

The aqueous dispersion according to the invention may optionally contain additives, for example in an amount of 0.1% to 30% by weight based on the total dispersion.

Components (C) that may be employed include for example plasticizers to make the resulting bond seams soft, flexible, stretchy and supple for use or further processing.

Plasticizers that may be employed include non-volatile, low-molecular weight compounds bearing polar groups. Preferred plasticizers are di(phenoxyethyl) formal and non-volatile esters based on aromatic carboxylic acids such as phthalic acid, isophthalic acid, terephthalic acid, benzoic acid, trimellitic acid; on aliphatic carboxylic acids such as maleic acid, fumaric acid, succinic acid, acetic acid, propionic acid, butyric acid, adipic acid, azelaic acid, sebacic acid, citric acid, cyclohexanedicarboxylic acid, or on fatty acids such as oleic acid, ricinoleic acid or stearic acid; and phosphoric, sulfonic or alkylsulfonic esters. Preference is also given to epoxidized vegetable oils such as epoxidized linseed oil and epoxidized soybean oil. It is particularly preferable to employ di(phenoxyethyl)formal, dibutyl terephthalate and alkylsulfonic esters of phenol, very particularly preferably di(phenoxyethyl)formal and dibutyl terephthalate. In a particularly preferred embodiment of the present invention di(phenoxyethyl)formal is employed as plasticizer (component C).

In the dispersion according to the invention the at least one plasticizer is generally present in an amount of 0.1% to 30% by weight, preferably 15% to 25% by weight, in each case based on the total dispersion.

It is further possible to employ tackifier resins as component (C) to increase the adhesion of the adhesive. Suitable tackifier resins include natural and synthetic resins, for example aliphatic, aromatically modified, aromatic and hydrogenated hydrocarbon resins, terpene resins, modified terpene resins and terpene phenol resins, or tree resin derivatives such as for example colophony rosins, modified colophony rosins such as for example rosin esters based on colophony (rosin esters), balsam rosin derivatives (gum rosin) and tall oil derivatives (tall oil rosin). It will be appreciated that the tackifier resins may be employed individually or as mixtures.

The tackifier resins employed are preferably colophony rosins and modified colophony rosins. It is particularly preferable to employ rosin esters based on colophony. The tackifiers may be used as 100% resins or as a dispersion in the aqueous dispersions according to the invention provided they exhibit compatibility, in particular stability to phase separation.

In a particularly preferred embodiment of the present invention aqueous dispersions of colophony rosin esters (rosin ester dispersions) are employed as component C).

In the dispersion according to the invention the at least one tackifier resin is present in an amount of generally 0.1% to 30% by weight, preferably 15% to 25% by weight, in each case based on the total dispersion.

The aqueous dispersion may optionally be admixed with at least one flame retardant as component (C) to increase the fire safety of the molded articles produced therefrom. Suitable flame retardants include for example organic phosphorus and nitrogen compounds, organochlorine and organobromine compounds, and also inorganic flame retardants, for example antimony trioxide, aluminium hydroxide or aluminium oxide. In the context of the present invention it is preferable to employ aluminium hydroxide as a flame retardant in the aqueous dispersion, particularly preferably aluminium hydroxide having an average particle size d(50) of 1.0 to 3.9 μm, in particular 1.7 to 2.1 μm.

In the dispersion according to the invention the at least one flame retardant is generally present in an amount of 0.1% to 30% by weight, preferably 1.5% to 15% by weight, in each case based on the total dispersion.

In a further, unpreferred, embodiment fungicides may also be added as component (C) for preservation. These are preferably employed in amounts of 0.02% to 0.5% by weight based on the total dispersion. Suitable fungicides are, for example, phenol and cresol derivatives or organotin compounds.

Further possible additional additives (component C) include for example pigments, flame retardants, antioxidants, dispersants, emulsifiers, wetting agents, adhesion promoters and/or defoamers.

Also employable as further additives are aging protectants, antioxidants and/or UV protectants, in particular based on oligofunctional, secondary aromatic amines or oligofunctional, substituted phenols, such as products of the type 6-PPD (N-(1,3-dimethylbutyI)-N′-phenyl-p-phenylendiamine), for example Vulkanox® from Lanxess Deutschland GmbH, DTPD, DDA, BPH, BHT or compounds based on HALS (hindered amine light stabilisers), benzotriazoles, oxalanilides, hydroxybezophenones and/or hydroxyphenyl-S-triazines. Rhenofit® DDA 50 EM, a diphenylamine derivative from Rhein Chemie, is particularly effective.

Corresponding aging protectants, antioxidants and/or UV protectants are typically introduced in emulsified form as an aqueous dispersion.

In the dispersion according to the invention aging protectants, antioxidants and/or UV protectants are generally present in an amount of 0.1% to 2.5% by weight, preferably 0.5% to 1.5% by weight, particularly preferably 0.75% to 1.25% by weight, in each case based on the total dispersion.

In the dispersion according to the invention component (C) is generally present in an amount of 0.1% to 30% by weight, preferably 15% to 25% by weight, in each case based on the total dispersion.

The aqueous dispersion according to the invention may be used for example in the thermal activation process. This is known per se to a person skilled in the art.

The aqueous dispersion according to the invention is preferably used for bonding by the spray coagulation process. In this process, the aqueous adhesive formulations and also a coagulant are conveyed separately in a two-component spray gun and mixed in the spray jet.

Suitable coagulants include aqueous solutions of salts, preferably of metals of the first, second and third main group of the periodic table, in particular those that exhibit good water solubility. It is preferable to employ salts based on divalent or trivalent cations. It is particularly preferable to employ calcium chloride, zinc sulfate or aluminium sulfate. Very particular preference is given to using calcium chloride. It is also possible to employ mixtures of different salts according to the above description as an aqueous solution.

The concentration of the aqueous salt solutions suitable as coagulant is 1% to 20% by weight, preferably 2% to 10% by weight and particularly preferably 3% to 4% by weight, in each case based on the aqueous salt solution.

The proportion of the aqueous solution of the coagulant is preferably 0.1% to 50% by weight, preferably 1% to 30% by weight, particularly preferably 8% to 20% by weight and very particularly preferably 12% to 18% by weight, in each case based on the sum of the aqueous dispersion according to the invention and the coagulant solution.

The present invention therefore preferably relates to the aqueous dispersion according to the invention containing
A) 60% to 99.9% by weight, preferably 85% to 99.6% by weight, of the at least one anionically hydrophilized polyurethane,
B) 0.1% to 40% by weight, preferably 0.2% to 30% by weight, particularly preferably 0.4% to 15% by weight, of the at least one fresh sol,
C) 0.1% to 30% by weight of further additives,
in each case based on the total weight of the aqueous dispersion, wherein the components present sum to 100% by weight in each case.

Especially for use in spray application the aqueous dispersion according to the invention preferably has a viscosity of 500 to 7000 mPas, particularly preferably 1500 to 6000 mPas, in each case determined according to DIN ISO 2555: 2018-09 using a Brookfield rotational viscometer.

In a preferred embodiment of the present invention the aqueous dispersion according to the invention is produced by mixing an aqueous dispersion containing at least one polyurethane with the at least one fresh sol and the optionally present further additives.

The present invention therefore also relates to a process for producing the aqueous dispersion according to the invention, wherein an aqueous dispersion containing at least one polyurethane is mixed with an aqueous solution of the silica, i.e. the fresh sol, and optionally further additives. Process parameters suitable therefor are known per se to those skilled in the art; for example production is carried out at a temperature of 20° C. to 28° C., further preferably in a stirred reactor.

The present invention also relates to the use of the dispersion according to the invention for producing an adhesive composition. Components that may be present in the adhesive composition according to the invention in addition to the aqueous dispersion according to the invention are known per se to those skilled in the art and/or have already been described above. Additional additives for an adhesive composition may be selected from water-based acrylic resins, for example Acronal® from BASF, microfibrillated cellulose, for example Exilva® from Borregaard, and/or other thickener systems known to those skilled in the art.

It is preferable according to the invention when the aqueous dispersion according to the invention corresponds to the adhesive composition according to the invention, i.e. the adhesive composition according to the invention consists of the aqueous dispersion according to the invention.

The present invention also relates to an adhesive composition at least containing an aqueous dispersion according to the invention, preferably consisting of the aqueous dispersion according to the invention.

The present invention moreover also relates to an adhesive laminate containing at least one substrate bonded with an adhesive composition according to the invention.

The present invention in particular relates to the adhesive laminate according to the invention, wherein the at least one substrate is selected from the group consisting of wood, paper, thermoplastics, elastomeric plastics, thermoplastic-elastomeric plastics, vulcanizates, textile fabrics, knits, braids, leather, metals, ceramics, asbestos cement, masonry, concrete, foams and combinations thereof. In the adhesive laminate according to the invention the recited substrates are preferably in each case bonded to one another and/or to porous substrates, preferably with a density of less than 1 kg/liter.

The present invention also relates to a process for producing an adhesive laminate, wherein at least one substrate is bonded with the adhesive composition according to the invention.

The adhesive composition according to the invention, in particular the aqueous dispersion according to the invention, may generally be applied to the at least one substrate using all commonly used forms of application, in particular by painting, rolling, atomizing and/or spraying, in particular by spray application, brush application or roller application. Application of the adhesive composition according to the invention is preferably carried out by spray application.

Substrates suitable according to the invention have already been recited above.

In particular the present invention relates to the process according to the invention for producing a wet-on-wet bond, wherein an adhesive composition according to the invention containing the aqueous dispersion according to the invention is applied to a foam substrate for example by spray application, roller application or brush application and after a flash-off time of <5 min, preferably <2 min, particularly preferably 1 min, wet bonding is achieved prior to film formation.

The present invention also relates to the use of the aqueous dispersion according to the invention for bonding of wood, paper, thermoplastics, elastomeric plastics, thermoplastic-elastomeric plastics, vulcanizates, textile fabrics, knits, braids, leather, metals, ceramics, asbestos cement, masonry, concrete, foams and combinations thereof. According to the invention the recited substrates are preferably respectively bonded to one another and/or to porous substrates, preferably with a density of less than 1 kg/liter.

The present invention also relates to the use of a fresh sol for achieving a thickening effect in an aqueous polyurethane dispersion. Addition of the fresh sol in an amount of 5% to 40% by weight based on the resulting aqueous polyurethane dispersion preferably causes the viscosity to increase by 400 to >50 000 mPa·s, preferably 1000 to 4500 mPa·s.

The invention shall be more particularly elucidated with reference to the following examples without any intention to restrict it thereto.

### Examples

Table 1 shows the components employed in the inventive examples and/or comparative examples.

TABLE 1

| | Origin/ | | |
|---|---|---|---|
| Type | trade name | Properties/structure | Employed form |
| polyurethane | from example | anionically hydrophilized, semicrystalline | 40% by weight |
| dispersion | 1 | polyurethane | aqueous dispersion |
| polyurethane | Dispercoll ® | anionically hydrophilized, semicrystalline | 40% by weight |
| dispersion | U53 | polyurethane | aqueous dispersion |
| polyurethane | Dispercoll ® | anionically hydrophilized, amorphous | 50% by weight |
| dispersion | U42 | polyurethane | aqueous dispersion |
| polyurethane | Dispercoll ® | anionically hydrophilized, semicrystalline | 48% by weight |
| dispersion | U66 | polyurethane | aqueous dispersion |
| polyurethane | Baybond ® 406 | nonionic polyurethane | 35% by weight |
| dispersion | | | aqueous dispersion |
| polyurethane | Baybond ® | nonionic polyurethane | 50% by weight |
| dispersion | 1810-1 | | aqueous dispersion |
| fresh sol | Levasil ® CS6 - | aqueous solution of silica and oligosilicic | 6% by weight |
| | 3 P | acids | aqueous solution |
| silica sol | Levasil ® CS - | aqueous, colloidal solution of SiO₂, | 15% by weight |
| | 350 P | Al-modified | aqueous colloidal |
| | | | solution |
| silica sol | Dispercoll ® | aqueous, colloidal solution of SiO₂ | 30% by weight |
| | S3030 | | aqueous colloidal |
| | | | solution |
| thickener | Borchi Gel ® | polyacrylate, viscosity 25 000 to 60 000 | 5% by weight |
| | ALA | mPa · s | aqueous dispersion |
| plasticizer | Benzoflex 9-88 | mixture of dipropylene glycol dibenzoate | Viscosity at 25° C. |
| | | (CAS no. 2713831-4) and optionally further | about 105 mPa · s |
| | | benzoic esters | |

Methods of Measurement

Application of the Adhesive Formulation and Assessment

1) Spray Method

A standard spray gun for two-component dispersion adhesives (PILOT III 2K from Walther Pilot) was used for application. The adhesive and the coagulant CaCl₂) (3% by weight solution in water) were conveyed into the spray gun separately and mixed in the spray jet, thus coagulating the adhesive.

Since the mixing only occurred in the spray jet there was no need to take any pot life into account. A ratio of 86% by weight of adhesive dispersion to 14% by weight of CaCl₂) solution was selected.

The quantity ratios and the application weight were determined by reweighing the reservoir vessel and the substrates.

The following spray gun settings were employed:
Adhesive component: conveying pressure 1.3 bar
Coagulation component: conveying pressure 0.3 bar
Atomizer air pressure: 2.8 bar
Bore (nozzle) for adhesive component 1.0 mm
Bore (nozzle) for coagulation component 0.4 mm
Applied weights: 100 to 200 g/m² (wet)

2) Coating with a Brush

The adhesive formulation was applied to both sides of the PU foam body using a brush.

3) Test Specimen

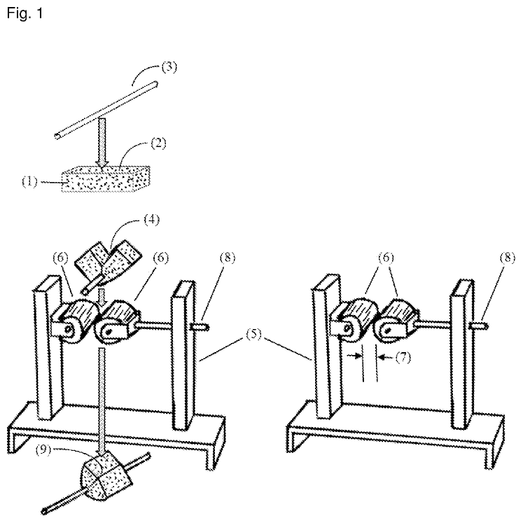

PU foam bodies from stn/schaumstoff-technik-Nürnberg GmbH were used. Type ST 5540, dimensions of the test specimen: 101 mm×49 mm×30 mm, material basis PUR, color white, gross weight 40 kg/m², net bulk density 38 kg/m³ according to ISO-845: 2009-10, compression hardness at 40% 5.5 (kPa) according to DIN EN ISO 3386: 2015-10, tensile strength >120 kpa according to DIN EN ISO 1798: 2008-04, elongation at break >110% according to ISO-1798: 2008-04, compression set <4 according to DIN EN ISO-1856: 2018-11 (50%70° C./22 h)
4) Determination of initial strength (see also FIG. 1)

The test specimens recited at 3) were used as the test material. For assessment of initial strength, immediately after adhesive application to the upper surface (2) of the foam bodies (1) by the spray coagulation process (application rate 130 to 150 g/m² wet), the test specimens were folded (4) in the middle with a wooden rod (3) (7×7 mm rectangle) and passed using the test apparatus (5) through 2 steel rollers (6) (diameter 40 mm in each case, length 64 mm in each case), the tangential spacing (7) of which had previously been adjusted to 10 mm using a threaded spindle (8).

5) Evaluation of Initial Strength

An immediate initial strength was present when the test specimen or the bonded seam (9) no longer opened despite the restoring forces present in the test specimen.

Better quantification of initial strength was achieved by evaluation as follows:

The tension was immediately held after puffing the test specimen through the nip between the two rollers once. If the foam body was pulled apart on both sides after 120 s and material tear-out occurred or said body could only be opened again with application of a very high force, the initial strength was rated “1”.

The tension was immediately held after pulling the test specimen through the nip between the two rollers once. If the foam body could be opened again after 120 s by pulling it apart on both sides without great effort the initial strength was rated “2”.

The test specimen opened after pulling the test specimen through the nip between the two rollers once. Only through repetition or by exerting manual pressure (1× about 1 s of pressure) did the test specimen remain closed, rating “3”.

The tension was not held even after repeated pressing (using rollers and manually), rating “4”.

Determination of Viscosity

The viscosity of the dispersions was determined using a Brookfield viscometer according to DIN ISO 2555: 2018-09. To this end the spindle was carefully immersed into the dispersion to be measured, ideally without air bubble formation. To this end the bottle containing the sample to be analysed was placed on a lift and initially raised until the spindle was able to be secured to the drive shaft without the spindle body emerging from the dispersion. The lift was raised further until the spindle was immersed in the sample up to the immersion groove on the spindle shaft. The motor was switched on. As soon as the LED display of the measured value had stabilized, the measured value was read off.

Depending on the viscosity range, the procedure was as follows:
Viscosity range <1000 mPa·s: measurement with spindle #2 at 60 rpm.
Viscosity range 1000 to 2500 mPa·s: measurement with spindle #2 at 12 rpm.
Viscosity range 2500 to 10000 mPa·s: measurement with spindle #3 at 12 rpm.

Determination of pH

A single-probe measurement electrode (Metrohm pH meter) was immersed in the dispersion or solution to be tested.

Heat Resistance

Determining the heat resistance of the wood/PVC adhesive bonds employed the following procedure:

Test Specimens

The analyses were carried out on beechwood/uPVC laminating film. The rigid PVC laminating film was obtained from Benecke-Kaliko AG, Beneckeallee 40, D-30419 Hanover. Type: Renolit nature, dimensions 50 mm×250 mm×0.4 mm. The film was cut into the appropriate test specimen width (50 mm) and test specimen length (210 mm).

The beechwood was obtained from Rocholl GmbH, Alter Gartenweg 6-8, 69436 Schönbrunn-Moosbrunn. Type beechwood, planed and holed, dimensions 50 mm×140 mm×4.0 mm. The bonding area is 50 mm×110 mm.

Adhesive application was onto a bonding surface of 50 mm×110 mm as a double brush-application onto the beechwood only (1st application 30 min., 2nd application 60 min.). Drying was carried out at room temperature atmospheric humidity of 50% to 75% in a paternoster. Once the drying time had elapsed the two test specimens were placed on top of one another such that the unstructured side of the uPVC laminating film lay flush against the side of the beechwood specimen coated with adhesive.

This laminate was then placed in the membrane press with the beechwood side down and pressed under the following standard conditions:

Temperature setting of the press 103° C. (corresponding to a joint temperature of 90° C.), pressure 4 bar, pressing time 10 seconds.

The protruding end of the uPVC laminating film was holed in the middle.

After 4 to 7 days of storage at room temperature, the test specimens were examined in the heat resistance test. To this end the free end of the beech test specimen was first clamped in the clamps of the measuring sites of the heat resistance cabinet. The weight (500 g) was attached to the protruding end of the rigid PVC laminating film and loaded. This kept the adhesive bond at a 180° angle. The heat resistance cabinet was initially heated to 50° C. and then maintained at 50° C. for 60 min. The temperature in the heat resistance cabinet was then increased in 10° C. temperature steps for 60 minutes. The final temperature was 120° C. The time until complete peel-off of the PVC film is determined automatically.

Production of the Adhesive Formulations

The experiments were each carried out in a 900 ml poly beaker with a VISCO JET® stirrer at a stirring speed of about 600 rpm and a stirring time of 15 minutes. The polyurethane component is initially charged before the further components Levasil oder Dispercoll S were added. When adding Borchi Gel® A LA this was previously diluted with water in a 1:1 quantity ratio.

After the subsequent stirring time of 15 minutes the pH and the viscosity were measured. Viscosity is measured using spindle #63 at 12 rpm. The highest instantaneous value and the viscosity value attained for about 15 s were documented. The pH is then determined according to DIN ISO 976: 2016-12.

The experiments with “fresh sol” were performed exclusively with fresh fresh sol (not older than 12 hours).

### Example 1: Production of an Aqueous Polyurethane Dispersion

Input Materials:
Polyester polyol I: polyester diol formed from 1,4-butanediol and adipic acid, OH number=50
Desmodur® H: hexamethylene 1,6-diisocyanate (Covestro Deutschland AG, Leverkusen/Germany)
Desmodur® I: isophorone diisocyanate (Covestro Deutschland AG, Leverkusen/Germany)

450 g of polyester polyol I were dewatered at 110° C. and 15 mbar for 1 hour. At 80° C., 30.11 g of Desmodur® H and then 20.14 g of Desmodur® I were added. The mixture is stirred at 80° C. to 90° C. until a constant isocyanate content of 1.15% by weight has been achieved. The reaction mixture was dissolved in 750 g of acetone and cooled to 48° C. A solution of 5.95 g of the sodium salt of N-(2-aminoethyl)-2-aminoethanesulfonic acid and 2.57 g of diethanolamine in 65 g of water was added to the homogeneous solution with vigorous stirring. After 30 minutes, the mixture was dispersed by addition of 700 g of water. Distillative removal of the acetone afforded an aqueous polyurethane dispersion having a solids content of 40.0% by weight. The polymer present is semicrystalline after drying with a melting temperature of 48° C. and an enthalpy of fusion of 50.4 J/g.

Production of Adhesive Formulations

The components recited in table 1 are used to produce the formulations recited in tables 2 to 6 which are analyzed in terms of viscosity, pH, heat resistance and storage stability.

TABLE 2
Use of fresh sol in aqueous dispersions containing anionically
hydrophilized polyurethanes

| | Example no. | | | | | | | | |
|---|---|---|---|---|---|---|---|---|---|
| | 2 | 3 | 4 | 5 | 6 | 7 | 8 | 9 | 10 |
| Polyurethane from | 95 | 90 | 80 | 70 | 60 | 76 | 72 | 64 | 56 |
| example 1 | | | | | | | | | |
| Dispercoll ® U42 | — | — | — | — | — | 19 | 18 | 16 | 14 |
| Levasil ® CS 6-3P | 5 | 10 | 20 | 30 | 40 | 5 | 10 | 20 | 30 |
| pH | 6.9 | 6.8 | 6.6 | 6.2 | 6.0 | 7.6 | 7.3 | 6.6 | 6.5 |
| Viscosity [mPa · s] | 1230 | 3770 | 19000 | >50000 | Paste | 330 | 2200 | 9000 | Paste |

All reported data in % by weight unless otherwise stated.

In inventive experiments 2 to 10 adhesive formulations containing fresh sol and anionically hydrophilized polyurethane were produced and stored. It was found that under these conditions the fresh sol did not condense to afford a polysilicic acid with gel formation but rather interacted with the polyurethane, thus increasing the viscosity of the formulation.

TABLE 3
Use of fresh sol in aqueous dispersions containing anionically hydrophilized polyurethanes

| | Example no. | | | | | | | | | | | | | | |
|---|---|---|---|---|---|---|---|---|---|---|---|---|---|---|---|
| | 11 | 12 | 13 | 14 | 15 | 16 | 17 | 18 | 19 | 20 | 21 | 22 | 23 | 24 | 25 |
| Polyurethane from example 1 | 95 | 90 | 85 | — | — | — | — | — | — | 76 | 72 | 68 | — | — | — |
| Dispercoll ® U53 | — | — | — | 95 | 90 | 85 | — | — | — | — | — | — | — | — | — |
| Dispercoll ® U42 | — | — | — | — | — | — | 95 | 90 | 85 | 19 | 18 | 17 | — | — | — |
| Dispercoll ® U66 | — | — | — | — | — | — | — | — | — | — | — | — | 95 | 90 | 85 |
| Levasil ® CS 6-3P | 5 | 10 | 15 | 5 | 10 | 15 | 5 | 10 | 15 | 5 | 10 | 15 | 5 | 10 | 15 |
| Viscosity [mPa · s] | 470 | 4000 | 8000 | 1200 | 1800 | 3600 | 2290 | 6700 | 20000 | 260 | 2500 | 6000 | 390 | 930 | 4790 |
| pH | 6.5 | 6.2 | 6.1 | 6.7 | 6.7 | 6.6 | 7.5 | 7.3 | 7.2 | 7.5 | 7.2 | 6.9 | 6.3 | 6.1 | 6.1 |

All reported data in % by weight unless otherwise stated.

TABLE 4
Use of fresh sol in aqueous dispersions
containing nonionic polyurethanes

| | Example no. | | | | | |
|---|---|---|---|---|---|---|
| | C26 | C27 | C28 | C29 | C30 | C31 |
| Baybond ® PU 406 | 95 | 90 | 85 | — | — | — |
| Baybond ® PU 1810-1 | — | — | — | 95 | 90 | 85 |
| Levasil ® CS 6-3P | 5 | 10 | 15 | 5 | 10 | 15 |
| Viscosity [mPa · s] | 33 | 25 | 20 | 29 | 23 | 23 |
| pH | 7.7 | 7.6 | 7.4 | 6.8 | 6.5 | 6.6 |

All reported data in % by weight unless otherwise stated.
C comparative experiment

The use of fresh sol in dispersions of nonionic polyurethanes did not result in an observable viscosity increase.

TABLE 5
Use of silica sols in polyurethane dispersions

| | Example no. | | | | | | | | | | | | | |
|---|---|---|---|---|---|---|---|---|---|---|---|---|---|---|
| | C32 | C33 | C34 | C35 | C36 | C37 | C38 | C39 | C40 | C41 | C42 | C43 | C44 | C45 |
| Polyurethane | 95.74 | — | — | 76.59 | — | — | — | 97.83 | — | — | — | — | 78.26 | — |
| from example 1 | | | | | | | | | | | | | | |
| Dispercoll ® U53 | — | 93.41 | — | — | — | — | — | — | 96.59 | — | — | — | — | — |
| Dispercoll ® U42 | — | — | 97.94 | 19.15 | — | — | — | — | — | 98.96 | — | — | 19.57 | — |
| Dispercoll ® U 66 | — | — | — | — | 93.41 | — | — | — | — | — | 96.59 | — | — | — |
| Baybond ® | — | — | — | — | — | 93.41 | — | — | — | — | — | 96.59 | — | — |
| PU 406 | | | | | | | | | | | | | | |
| Baybond ® | — | — | — | — | — | — | 93.41 | — | — | — | — | — | — | 96.59 |
| PU 1810-1 | | | | | | | | | | | | | | |
| Dispercoll ® | — | — | — | — | — | — | — | 2.17 | 3.41 | 1.04 | 3.41 | 3.41 | 2.17 | 3.41 |
| S 3030 | | | | | | | | | | | | | | |
| Levasil ® | 4.26 | 6.59 | 2.06 | 4.26 | 6.59 | 6.59 | 6.59 | — | — | — | — | — | — | — |
| CS 15-350 P | | | | | | | | | | | | | | |
| Viscosity | 27 | 21 | 40 | 23 | 29 | 97 | 44 | 41 | 38 | 93 | 68 | 250 | 55 | 232 |
| [mPa · s] | | | | | | | | | | | | | | |
| pH | 7.1 | 8.2 | 7.9 | 8.2 | 8.4 | 8.4 | 7.5 | 7.4 | 8.7 | 8.3 | 8.7 | 8.9 | 8.5 | 7.9 |

All reported data in % by weight unless otherwise stated.
C comparative experiment

In contrast to fresh sol, silica sols showed no thickening effect in polyurethane dispersions.

TABLE 6
Long-term storage stability of aqueous formulations containing fresh sol
and anionically hydrophilized polyurethanes (replicate experiments)

| | Example no. | | | | | |
|---|---|---|---|---|---|---|
| | 46 | 47 | 48 | 49 | 50 | 51 |
| Polyurethane from example 1 | 95 | 90 | 85 | 76 | 72 | 68 |
| Dispercoll ® U 42 | — | — | — | 19 | 18 | 17 |
| Levasil ® CS 6-P3 | 5 | 10 | 15 | 5 | 10 | 15 |
| Viscosity [mPa.s] | 470 | 4000 | 8000 | 260 | 2500 | 6000 |
| pH | 6.5 | 6.2 | 6.1 | 7.5 | 7.2 | 6.9 |
| Viscosity after 2 months | 420 | 3200 | 5800 | 240 | 2400 | 5100 |
| [mPa · s] pH after 2 months | 6.3 | 6.2 | 6.0 | 7.5 | 7.1 | 6.9 |
| Viscosity after 4 months | 380 | 2800 | 6200 | 210 | 2500 | 4700 |
| [mPa · s] pH after 4 months | 6.3 | 6.1 | 5.9 | 7.1 | 7.0 | 6.8 |

All reported data in % by weight unless otherwise stated.

Aqueous dispersions containing fresh sol and anionically hydrophilized polyurethanes were stable in terms of pH and viscosity over a lengthy storage period. Neither demixing nor coagulation was ob-served.

TABLE 7
Heat resistance and initial strength of aqueous formulations
containing fresh sol or an organic thickener and polyurethane

| Example no. | C52 | 53 | C54 | 55 |
|---|---|---|---|---|
| Polyurethane from example 1 | 99.5 | 95 | 98.64 | 90 |
| Levasil ® CS 6-P3 | — | 5 | — | 10 |
| Borchigel ® ALA | 0.5 | — | 1.36 | — |
| Viscosity [mPa · s] | 1440 | 1340 | 3310 | 3340 |
| pH | 6.6 | 6.9 | 6.8 | 6.8 |

Heat resistance measurement

| | | | | |
|---|---|---|---|---|
| Temperature [° C.] | 70 | 90 | 70 | 90 |
| Time [min.] | 136 | 251 | 153 | 274 |

Initial strength (2K process)

| | | | | |
|---|---|---|---|---|
| Test result | 2 | 1 | 2 | 1 |

All reported data in % by weight unless otherwise stated.
C Comparative example

In contrast to organic thickeners, in aqueous dispersions of anionically hydrophilized polyurethanes fresh sol not only acted as a thickener but also increased the heat resistance of the formulations independently of the mixture viscosity, by 20° C. for example, and additionally improved the initial strength in 2K spray application.

1. An aqueous dispersion at least containing
(A) at least one polyurethane,
(B) at least one fresh sol and
(C) optionally further additives,
wherein the at least one polyurethane is anionically hydrophilized.

2. The dispersion as claimed in claim 1, wherein the at least one polyurethane is semicrystalline or amorphous.

3. The dispersion as claimed in claim 1, wherein the dispersion contains
A) 60% to 99.9% by weight of the at least one anionically hydrophilized polyurethane,
B) 0.1% to 40% by weight of the at least one fresh sol,
C) 0.1% to 30% by weight of further additives,
in each case based on the total weight of the resulting wherein the components present sum to 100% by weight in each case.

4. The dispersion as claimed in claim 1, wherein the at least one polyurethane is formed from
a) at least one difunctional polyester polyol,
b) at least one polyisocyanate and
c) at least one chain extender,
d) optionally further units distinct from a), b) and c),
wherein at least one of the components a), b), c) and d) bears at least one anionically hydrophilizing group.

5. The dispersion as claimed in claim 4, wherein in the least one polyurethane the compound employed as component c) bears the at least one anionically hydrophilizing group.

6. The dispersion as claimed in claim 1, wherein the at least one fresh sol has a pH of 1.0 to 3.5.

7. A process for producing the dispersion as claimed in claim 1, wherein an aqueous dispersion containing at least one polyurethane is mixed with at least one fresh sol and optionally further additives.

8. An adhesive composition containing the dispersion as claimed in claim 1.

9. An adhesive laminate containing at least one substrate bonded with adhesive composition as claimed in claim 8.

10. The adhesive laminate as claimed in claim 9, wherein the at least one substrate is selected from the group consisting of wood, paper, thermoplastics, elastomeric plastics, thermoplastic-elastomeric plastics, vulcanizates, textile fabrics, knits, braids, leather, metals, ceramics, asbestos cement, masonry, concrete, foams and combinations thereof.

11. A process for producing an adhesive laminate, wherein at least one substrate is bonded with the adhesive composition as claimed in claim 9.

12. The process as claimed in claim 11, wherein the adhesive composition is applied to the at least one substrate by painting, rolling, atomizing and/or spraying, brush application or roller application.

13. A process for bonding of wood, paper, thermoplastics, elastomeric plastics, thermoplastic-elastomeric plastics, vulcanizates, textile fabrics, knits, braids, leather, metals, ceramics, asbestos cement, masonry, concrete, foams and combinations thereof in each case to one another and/or to porous substrates by applying the dispersion of claim 1.

14. A method for achieving a thickening effect in an aqueous polyurethane dispersion by preparing the dispersion of claim 1.

15. The dispersion as claimed in claim 1, wherein the at least one polyurethane has a glass transition temperature Tg of −65° C. to 10° C.

16. The dispersion as claimed in claim 4, where the at least one difunctional polyester polyol of component a) has a molecular weight of 400 to 5000 g/mol.

17. The dispersion as claimed in claim 5, wherein the at least one chain extender of component c) is selected from the group consisting of mono- and dihydroxycarboxylic acids, mono- and diaminocarboxylic acids, mono- and dihydroxysulfonic acids, mono- and diaminosulfonic acids and also mono- and dihydroxyphosphonic acids or mono- and diaminophosphonic acids, their alkali metal and ammonium salts and mixtures thereof.
